(19) United States
(12) Patent Application Publication
(10) Pub. No.: US 2024/0332879 A1
(43) Pub. Date: Oct. 3, 2024

(54) MANUFACTURING METHOD FOR UNIPOLAR TERMINAL BLOCK

(71) Applicant: Yazaki Corporation, Tokyo (JP)

(72) Inventors: Hiroaki ONO, Makinohara-shi (JP); Toru SUZUK, Makinohara-shi (JP)

(73) Assignee: Yazaki Corporation, Tokyo (JP)

(21) Appl. No.: 18/597,261

(22) Filed: Mar. 6, 2024

(30) Foreign Application Priority Data
Mar. 27, 2023 (JP) 2023-049260

(51) Int. Cl. H01R 43/24; H01R 9/24

(52) U.S. Cl. CPC H01R 43/24; H01R 9/24

(57) ABSTRACT

A manufacturing method for a unipolar terminal block including a terminal having a first connection portion and a second connection portion at both end sides thereof, and a resin portion holding the terminal includes using a mold unit including a plurality of molds forming a cavity for molding the resin portion, and a core configured to hold the terminal that is molded in advance and incorporated in one of the plurality of molds; preparing various types of terminals and various types of cores for holding the terminals respectively; and selecting one terminal from the various types of terminals and one core from the various types of cores, and filling molten resin into the cavity in a state in which the selected one core is incorporated in the mold and the one terminal is set in the cavity to manufacture the unipolar terminal block.

### TECHNICAL FIELD

The present invention relates to a terminal block.

### BACKGROUND ART

There are various structures included in terminal blocks for wiring connections, and an example thereof is shown in FIG. 9 (see Patent Document 1). A terminal block 500 shown in FIG. 9 is fixed to a housing of a travel motor mounted on a vehicle, and includes three busbars 502, two collars 503, and a housing 504 holding these configurations.

Each busbar 502 includes a first connection portion 521 and a second connection portion 522. The first connection portion 521, for example, is connected to a terminal of a motor for travelling. The second connection portion 522, for example, is connected to a terminal of an inverter.

The collar 503 is made of metal and has a cylindrical shape. A bolt for fixing the terminal block 500 to a housing of the motor for travelling is passed through the collar 503.

The housing 504 is made of insulating synthetic resin. The housing 504 is formed by filling a mold cavity with molten resin and solidifying the molten resin. Also, the busbar 502 and the collar 503 are set in the mold cavity when the housing 504 is molded, and are insert-molded into the housing 504.

In addition to the terminal block 500 described above, there are terminal blocks of various shapes to match the mounting conditions of each vehicle.

### CITATION LIST

### Patent Documents

[Patent Document 1] JP 2022-52013A

### SUMMARY OF THE INVENTION

### Technical Problem

With regard to manufacturing the terminal blocks of various shapes described above, it is necessary to construct a mold for each product, which leads to a problem of increasing development time and cost.

Accordingly, an object of the present invention is to provide a technology for sharing a mold to manufacture various types of unipolar terminal block.

### Solution to Problem

According to the present invention, a manufacturing method for a unipolar terminal block, wherein the unipolar terminal block includes a terminal having a first connection portion formed at one end side and a second connection portion formed at the other end side, and a resin portion holding the terminal, includes using a mold unit including a plurality of molds forming a cavity for molding the resin portion, and a core configured to hold the terminal that is molded in advance and incorporated in one of the plurality of molds; preparing various types of terminals and various types of cores for holding the terminals respectively; and selecting one terminal from the various types of terminals and one core from the various types of cores, and filling molten resin into the cavity in a state in which the selected one core is incorporated in the mold and the one terminal is set in the cavity to manufacture the unipolar terminal block.

### Effect of the Invention

According to the present invention, it is possible to share a mold to manufacture various types of unipolar terminal blocks.

### BRIEF DESCRIPTION OF THE DRAWINGS

FIG. 1 is a perspective view showing a unipolar terminal block that is manufactured by a manufacturing method according to an embodiment of the present invention.

FIG. 2 is a perspective view showing the unipolar terminal block in FIG. 1 from another angle.

FIG. 3 is a perspective view showing another example of the unipolar terminal block that is manufactured by the manufacturing method according to the embodiment of the present invention.

FIG. 4 is a perspective view showing further another example of the unipolar terminal block that is manufactured by the manufacturing method according to the embodiment of the present invention.

FIG. 5 is a schematic view showing a mold unit for molding a resin portion of the unipolar terminal block in FIG. 1, and a view showing a state in which the mold is closed.

FIG. 6 is a view showing a state in which the mold of the mold unit in FIG. 5 is opened.

FIG. 7A is a rear view showing a terminal block assembly structure in which the unipolar terminal block that is manufactured by the manufacturing method according to the embodiment of the present invention is attached to an attached portion.

FIG. 7B is a planar view showing a terminal block assembly structure in which the unipolar terminal block that is manufactured by the manufacturing method according to the embodiment of the present invention is attached to the attached portion.

FIG. 8A is a rear view showing another terminal block assembly structure in which the unipolar terminal block that is manufactured by the manufacturing method according to the embodiment of the present invention is attached to an attached portion.

FIG. 8B is a planar view showing another terminal block assembly structure in which the unipolar terminal block that is manufactured by the manufacturing method according to the embodiment of the present invention is attached to the attached portion.

FIG. 9 is a perspective view showing a conventional terminal block.

### DESCRIPTION OF EMBODIMENTS

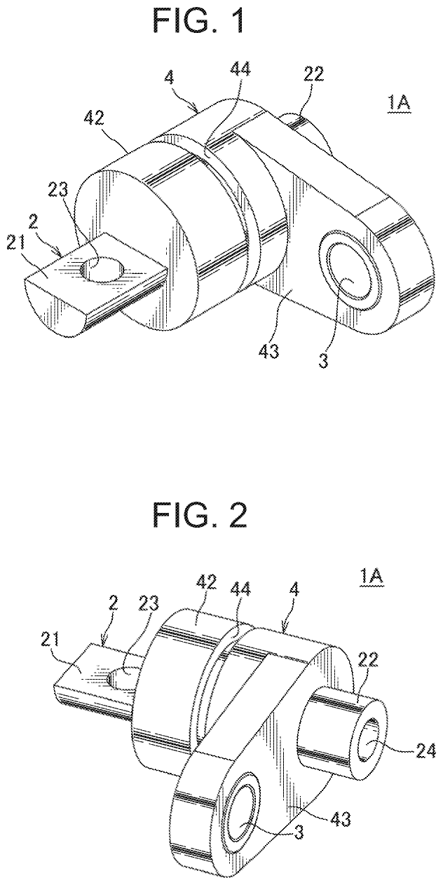

A “manufacturing method for a unipolar terminal block” according to an embodiment of the present invention will be described with reference to FIG. 1 to FIG. 6.

A unipolar terminal block 1A shown in FIG. 1 and FIG. 2 is a component for connecting wires to each other. This unipolar terminal block 1A includes a unipolar terminal 2 in which a first connection portion 21 is formed on one end side and a second connection portion 22 is formed at the other end side, a collar 3, and a resin portion 4 to hold the terminal 2 and the collar 3.

The first connection portion 21 is formed in a semi-cylindrical shape as a shape obtained by dividing a cylinder into two along a plane passing through a central axis thereof, and includes a bolt insertion hole 23.

The second connection portion 22 is formed in a cylindrical shape and includes a female threaded portion 24. The female threaded portion 24 includes a hole formed concavely from the other end of the terminal 2, and a screw cut spirally on the inner circumferential surface of the hole.

The collar 3 is made of metal and has a cylindrical shape. A bolt for fixing the unipolar terminal block 1A to an attached portion is passed through the collar 3.

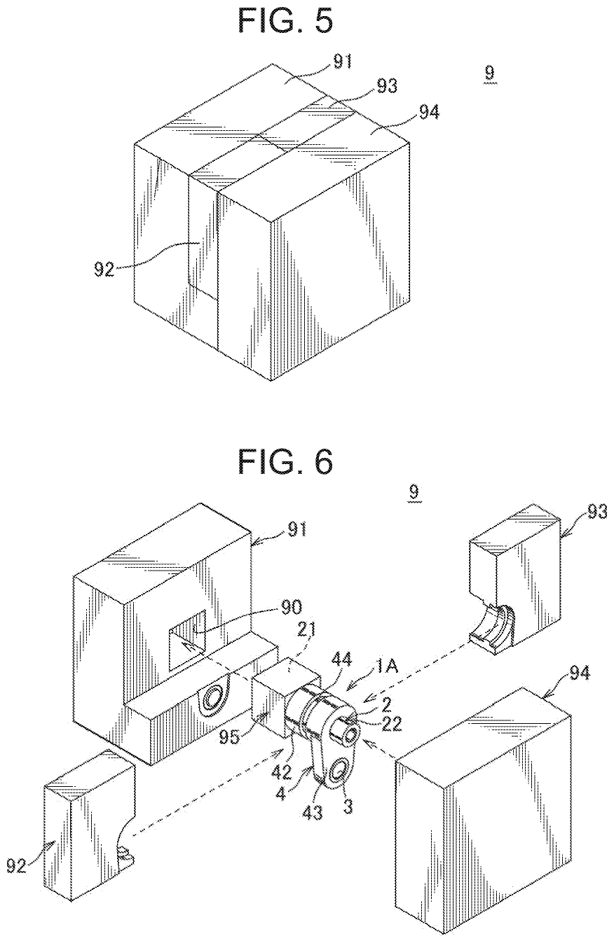

The resin portion 4 is formed in a mold unit 9 shown in FIG. 5 and FIG. 6, configured of an insulating synthetic resin, and includes a cylindrical terminal holding portion 42 and a plate-shaped collar holding portion 43 continuous to the outer circumferential surface of the terminal holding portion 42. An annular packing attachment groove 44 for attaching an annular packing is formed on the outer circumferential surface of the terminal holding portion 42.

The terminal 2 is insert-molded into the resin portion 4, wherein the first connection portion 21 protrudes from one end surface of the terminal holding portion 42, the second connection portion 22 protrudes from the other end surface of the terminal holding portion 42, and the central portion is embedded in the terminal holding portion 42.

The collar 3 is insert-molded into the resin portion 4. The outer circumferential surface of the collar 3 is covered by a collar holding portion 43. The central axis of the collar 3 is parallel to the central axis of the second connecting portion 22.

The mold unit 9 includes a plurality of molds 91, 92, 93, 94 configuring a cavity for molding the resin portion 4, and a core 95 configured to hold the terminal 2 that is molded in advance and is incorporated in a concave portion 90 of the mold 91. The core 95 is formed in a rectangular shape and includes a concave portion for positioning the first connection portion 21. The mold 94 disposed to be opposite to the mold 91 includes a concave portion for positioning the second connection portion 22, and a convex portion configured to hold the collar 3 that is molded in advance.

The unipolar terminal block 1A is manufactured by the following method. At first, the core 95 is incorporated in the concave portion 90 of the mold 91, and the terminal 2 that is molded in advance is attached to the core 95. Also, the collar 3 that is molded in advance is attached to the above-described convex portion of the mold 94. Next, as shown in FIG. 5, the molds 91, 92, 93, 94 are closed. In this manner, the molds 91, 92, 93, 94 are closed such that the cavity is formed, and the terminal 2 and the collar 3 is set in this cavity. Next, molten resin is filled within the cavity. Therefore, after a predetermined curing period, the molds 91, 92, 93, 94 are opened and the unipolar terminal block 1A as a finished product is taken out.

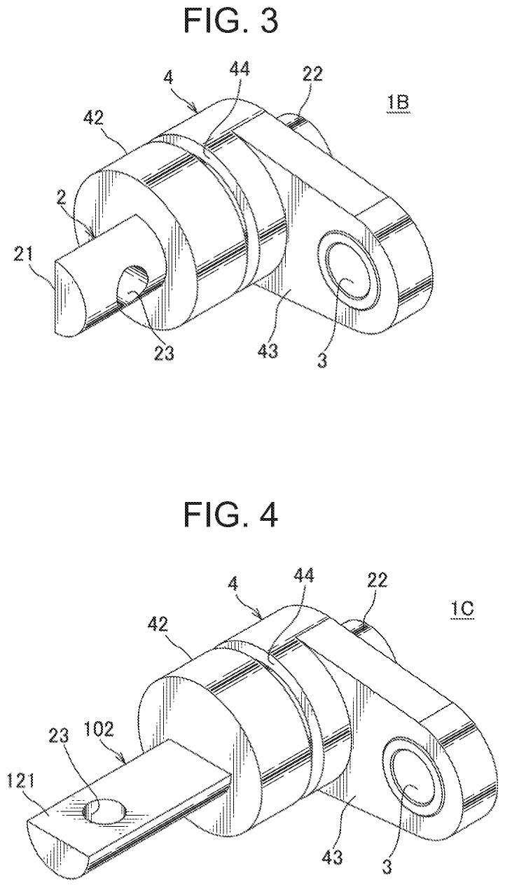

By replacing the core 95 with other members, the above-described mold unit 9 can manufacture a unipolar terminal block 1B shown in FIG. 3, a unipolar terminal block 1C shown in FIG. 4, and the like.

The unipolar terminal block 1B is different from the unipolar terminal block 1A in an orientation of the first connection portion 21 with respect to the collar 3, that is, the orientation of the bolt insertion hole 23, and other configurations thereof are the same with that of the unipolar terminal block 1A. The terminal 2 of the unipolar terminal block 1B and the terminal 2 of the unipolar terminal block 1A are the same members, and the specification is changed by rotating the orientation at 90 degrees by the core when setting in the mold unit 9.

The unipolar terminal block 1C uses a terminal 102 instead of the terminal 2, and other configurations thereof are the same with that of the unipolar terminal block 1A. The first connection portion 121 of the terminal 102 is longer than the first connection portion 21 of the terminal 2, and the position of the bolt insertion hole 23 is different from that in the unipolar terminal block 1A.

At the time of manufacturing the unipolar terminal block 1B, the above-described mold unit 9 is used, a core corresponding to the terminal 2 of the unipolar terminal block 1B is incorporated in the concave portion 90 of the mold 91, then the terminal 2 is attached to this core, and thereafter the unipolar terminal block 1B is manufactured by the same procedures at that when manufacturing the unipolar terminal block 1A.

At the time of manufacturing the unipolar terminal block 1C, the above-described mold unit 9 is used, a core corresponding to the terminal 102 of the unipolar terminal block 1C is incorporated in the concave portion 90 of the mold 91, then the terminal 102 is attached to this core, and thereafter the unipolar terminal block 1C is manufactured by the same procedures at that when manufacturing the unipolar terminal block 1A.

In this manner, according to the present example, it is possible to manufacture various types of the unipolar terminal blocks 1A, 1B, 1C by sharing the molds 91, 92, 93, 94 and changing the cores and insert members.

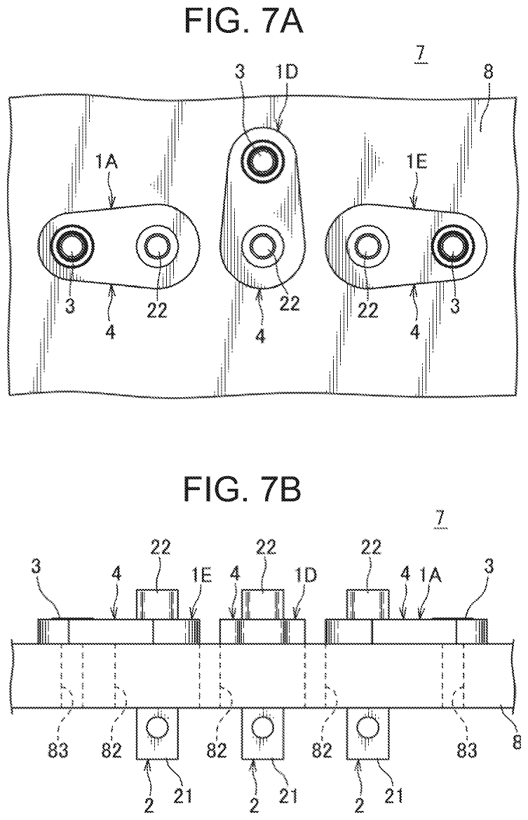

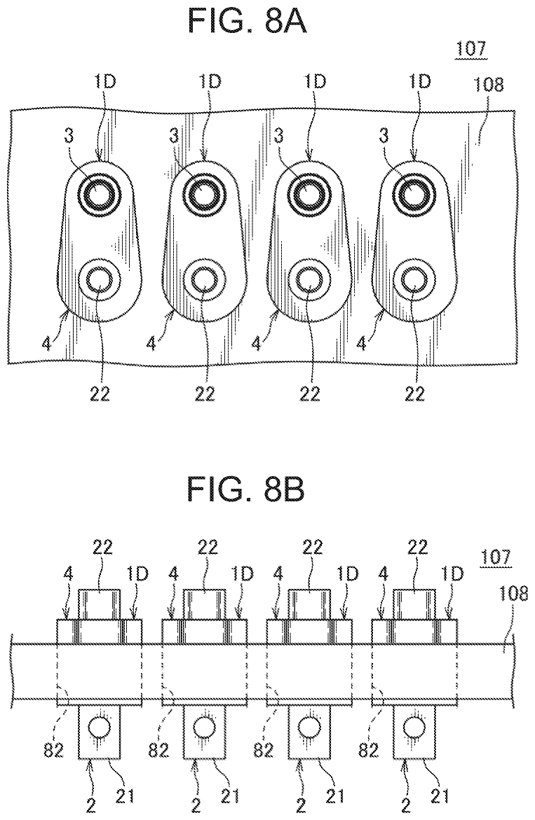

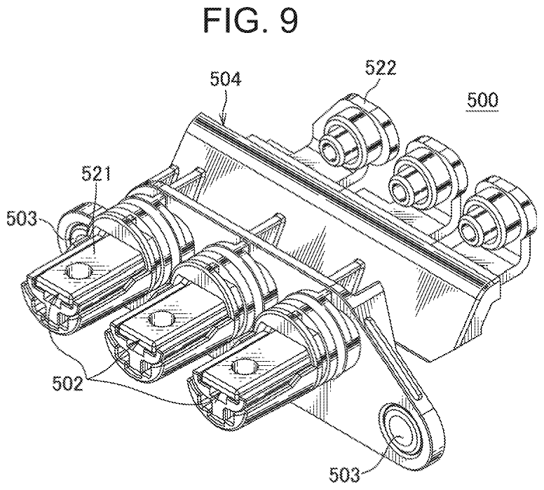

The unipolar terminal block obtained by the above-described manufacturing method is attached to an attached portion shown in FIG. 7A to FIG. 8B, for example.

A terminal block assembly structure 7 shown in FIG. 7A and FIG. 7B is configured that three unipolar terminal blocks 1A, 1D, 1E with different specifications are attached to an attached portion 8. The unipolar terminal blocks 1A, 1D, 1E use the same members as the terminal 2 and the collar 3, the orientation of the bolt insertion hole 23 with respect to the collar 3 is different from each other, and other configurations are the same. Either one of these is manufactured by sharing the above-described mold 91, 92, 93, 94.

The attached portion 8 is a casing of an inverter mounted on a vehicle. In the attached portion 8, three insertion holes 82 through which the terminal holding portions 42 of the unipolar terminal blocks 1A, 1D, 1E are inserted respectively, and three bolt insertion holes 83 through which the bolts inserting through the collars 3 of the unipolar terminal blocks 1A, 1D, 1E are inserted respectively, are formed.

Each unipolar terminal block 1A, 1D, 1E is inserted into each insertion hole 82, the bolt is inserted into each collar 3 and each bolt insertion hole 83, and a nut is screwed to the bolt such that each unipolar terminal block 1A, 1D, 1E is fixed to the attached portion 8. Further, the gap between the insertion hole 82 and the terminal holding portion 42 is sealed by the packing attached to the packing attachment groove 44 of each of the unipolar terminal blocks 1A, 1D, 1E.

As shown in FIG. 7B, the first connection portion 21 of each unipolar terminal block 1A, 1D, 1E is positioned at one side of the attached portion 8, that is, at the inner side of the casing. These first connection portions 21 are overlapped by terminals of the inverter, and then fastened together by the bolts inserted through the bolt insertion holes 23 and the nuts screwed to the bolts.

As shown in FIG. 7B, the second connection portion 22 of each unipolar terminal blocks 1A, 1D, 1E is positioned at the other side of the attached portion 8, that is, at the outer side of the casing. These second connection portions 22 are overlapped with the round terminals connected to the ends of the electric wires, and then are fastened together with the round terminals by the bolts screwed into the female screw portions 24.

Since such terminal block assembling structure 7 uses three unipolar terminal blocks 1A, 1D, 1E that are unconnected, it is possible to flexibly respond to changes of the positions of the bolt insertion holes 83 in the attached portion 8, changes of the pitch between the terminals 2, changes of the number of poles of the terminals 2, and the like.

The terminal block assembling structure 107 shown in FIG. 8A and FIG. 8B is configured that four unipolar terminal blocks 1D are attached to the attached portion 108. Similar to the terminal block assembling structure 7, this terminal block assembling structure 107 uses four unipolar terminal blocks 1D that are unconnected such that it is possible to flexibly respond to changes of the positions of the bolt insertion holes in the attached portion 108, changes of the pitch between the terminals 2, changes of the number of poles of the terminals 2, and the like.

Also, the above-described embodiment merely shows a typical embodiment of the present invention, and the present invention is not limited to this embodiment. That is, various modifications can be made without departing from the spirit of the present invention. Once the configurations according to the present embodiment are included, even if such modifications are applied, the configurations should be included within the scope of the present invention.

### REFERENCE SIGNS LIST

1A, 1B, 1C, 1D, 1E unipolar terminal block
2, 102 terminal
3 collar
4 resin portion
9 mold unit
91, 92, 93, 94 mold
95 core

What is claimed is:

1. A manufacturing method for a unipolar terminal block, wherein the unipolar terminal block includes a terminal having a first connection portion formed at one end side and a second connection portion formed at the other end side, and a resin portion holding the terminal, the manufacturing method comprising:
using a mold unit including a plurality of molds forming a cavity for molding the resin portion, and a core configured to hold the terminal that is molded in advance and incorporated in one of the plurality of molds;
preparing various types of terminals and various types of cores for holding the terminals respectively; and
selecting one terminal from the various types of terminals and one core from the various types of cores, and filling molten resin into the cavity in a state in which the selected one core is incorporated in the mold and the one terminal is set in the cavity to manufacture the unipolar terminal block.

2. The manufacturing method for a unipolar terminal block according to claim 1, wherein the first connection portion includes a bolt insertion hole, and the various types of the terminals are different from each other in a position or an orientation of the bolt insertion holes.

3. The manufacturing method for a unipolar terminal block according to claim 1,
wherein the unipolar terminal block includes a cylindrical collar that is held by the resin portion, and
the molten resin is filled in the cavity in a state in which the terminal and the collar are set in the cavity to manufacture the unipolar terminal block.
